(19) United States
(12) Patent Application Publication
(10) Pub. No.: US 2002/0062237 A1
(43) Pub. Date: May 23, 2002

(54) Transactional monitoring system and method

(76) Inventors: Scott Matsumoto, Andover, MA (US); Diane Downie, Nashua, NH (US); Robert Adams, Northampton, MA (US)

Correspondence Address: LUCASH, GESMER & UPDEGROVE, LLP, 40 BROAD ST, SUITE 300, BOSTON, MA, 02109, US

(21) Appl. No.: 09/922,272

(22) Filed: Aug. 3, 2001

Related U.S. Application Data
(60) Provisional application No. 60/223,188, filed on Aug. 4, 2000.

(51) Int. Cl. G06F 17/60

(52) U.S. Cl. 705/7; 705/1

(57) ABSTRACT

Disclosed are methods and systems for constructing a model of transactional object middleware components. The system collects and derives metrics based on events generated by the middleware during operation. Event data are correlated with business model information to provide a real-time, business-based view of transaction throughput in e-commerce and other business-related computing systems.

CROSS-REFERENCE TO RELATED APPLICATION

This application for patent claims the priority of commonly owned U.S. provisional application for patent Serial No. 60/223,188 filed Aug. 4, 2000, the disclosure of which is incorporated herein in its entirety by reference.

FIELD OF THE INVENTION

The present invention relates in general to methods, devices and systems for monitoring processing efficiency and throughput in digital processing systems, and in particular, relates to methods, devices and systems for providing a real-time, business-based view of transaction throughput in e-commerce and other business-related computing systems.

### BACKGROUND OF THE INVENTION

With the explosive growth of e-commerce and other online business computing systems, in banking, online marketplaces and other areas of commercial endeavor, comes an increasing need to monitor transaction processing throughput and efficiency. Online business owners, managers, administrators and others need answers to the questions such as “How efficiently is my online business system operating? Am I approaching the limits of my system? Do I need to add more computing resources to run my business?”

Many online businesses, which enable consumers to conduct money transfers or other banking transactions, make travel reservations or purchase a product, rely upon transaction processing systems, in which a user at a terminal can transmit commands to one or more applications programs (such as an online banking or travel reservation application). In turn, typical applications programs can perform many functions in real time, including updating relevant databases to make an airline reservation, debit a bank account, or create a purchase order.

However, in conventional monitoring systems intended for such transaction processing systems, the description provided of how the computer systems are performing, and their throughput, is usually couched in abstract terms, which relate only to how the computer itself is functioning. In many circumstances, the more important metric—how well is my computing system executing its intended banking/reservation/purchase order functions?—is unavailable.

The need for such monitoring has become especially acute in component-based transactional object system architectures typical of modem e-commerce solutions. In particular, software application architects now design systems in which the functions of the software application are segmented into distinct, logical pieces known as components. Frequently, several components work together to produce a single result (e.g., a completed banking transaction, airline reservation or consumer purchase). This component-based architecture has been adapted into transactional business systems known as transactional object systems. Businesses using this type of system must monitor in real-time how well their applications and systems are performing. Many types of metrics, including how many users are accessing the system, how long a transaction takes, how many components are active, and how many transactions are being processed, would be extremely useful for a business to monitor and use to improve the efficiency of the business computing resources.

Conventional monitoring techniques, however, cannot provide real-time, non-intrusive monitoring of the transactions being processed by such system architectures.

Accordingly, it would be useful to provide systems adapted to yield real-time, non-intrusive monitoring of transactions in a e-commerce and other business-related computing systems, particularly those utilizing component based, transactional object architectures.

In addition, it would be useful to provide such systems that enable not only a physical, computational view of e-commerce or other business-related software/hardware systems, but also a business view that enables answers to IT manager/administrator questions like those noted above.

### SUMMARY OF THE INVENTION

The present invention provides system, devices and methods for constructing a business view of an e-commerce or other business computing system's throughput, in terms of business transactions. This is accomplished through non-intrusive correlation of low-level system events. The present invention is adapted to monitor business transaction processing in a component-based application environment, in which each application may emit a stream of Events (representative of state transitions or other significant occurrences).

In one embodiment, the present invention detects Events, correlates or maps them into Transactions (each assigned a Business Name corresponding to a portion of a Business View or Business Model of the computing system or applications program), and correlates the Transactions into a Business View.

In a particular practice of a monitoring system according to the invention, the system detects Events, captures corresponding event data, and stores the data in a buffer. The event data identify the application that generated the event and the time of the event generation. Event data from the various applications are then correlated into a correlation buffer according to the time of the event generation. Each event is correlated with at least one other one other event to create a merged event. A model of the components of the application is created from the merged events, and a Transaction is mapped from the model and other merged events. The set of Transactions are then collected to form a real-time transactional model of the business transaction processing. In addition, the monitoring system can detect events generated by the operating system in which the applications program is executing, yielding data that describe the process executing the Transactions. These system events can be correlated with the executed Transactions to generate a performance curve of the application, enabling a business-related evaluation of the performance of the business computing system.

The invention thus forms a bridge between a physical, computational view of an e-commerce or other business-related software/hardware system, and a business view of that system. By correlating transactional performance and system performance over time, the invention draws a direct correlation between the computational limits and the business limits, and provides real-time answers to questions such as “How efficiently is my online business system operating? Am I approaching the limits of my system? Do I need to add more computing resources to run my business?”

### BRIEF DESCRIPTION OF THE DRAWINGS

Exemplary (though by no means the only) embodiments and practices of the present invention are set forth in the attached drawing figures, in which:

FIG. 1 depicts an example of the manner in which a management software application using the transaction monitoring system of the invention communicates with customer service applications, electronic supply chain applications and web store applications.

FIG. 2 depicts exemplary inputs and outputs of the transaction monitoring system of the invention that resides in the management software of FIG. 1.

FIG. 2B illustrates the relationship between events, transactions and activities in the transaction monitoring system of the invention.

FIG. 3 depicts an example of a transaction object environment in which the invention operates.

FIG. 4 depicts an example of the correlation of transaction object events in accordance with the invention.

FIG. 5 provides examples of transaction object events in the invention.

FIG. 6 depicts how one embodiment of the invention operates to collect transaction object events.

FIG. 7 shows an example of a probe-correlation architecture of the invention.

FIG. 8 depicts an example of probe architecture in accordance with the invention.

FIG. 9 depicts examples of correlation between transaction throughput and system throughput.

FIG. 10 depicts an example of a method of name construction in accordance with the invention.

FIG. 11 illustrates an embodiment of the Event Factory in the monitoring system of the invention.

FIG. 12 depicts an example of application and process metrics at application startup.

FIG. 13 provides further detail of a method for application and process metrics.

FIG. 14 illustrates a method for establishing activity context.

FIG. 15 depicts a method for object creation metrics.

FIG. 16 shows an example of a method for component activation.

FIG. 17 provides an example of a method call algorithm in accordance with the invention.

FIG. 18 shows an example of coordinated transaction handling in accordance with the invention.

FIG. 19 depicts exemplary handling of method return and method exception.

FIG. 20 illustrates the handling of object deactivation.

FIG. 21 depicts the handling of object destruction.

FIG. 22 shows a method of application process termination.

FIG. 23 illustrates a method of handling aggregate and throughput object metrics in accordance with the invention.

### DETAILED DESCRIPTION OF THE INVENTION

Overview

The present invention provides methods and systems that enable managers, administrators and other users of software applications to monitor the processes (and particularly the business processes) executed by those applications. The invention is based on the monitoring of Events, Transactions and Activities, and the correlation of those features in such a way as to provide an immediate, real-time model of the functions of the business. The invention thus provides real-time answers to questions such as: “How efficiently is my online business operating? Am I approaching the limits of my system? Do I need to add more computing resources to run my business?”

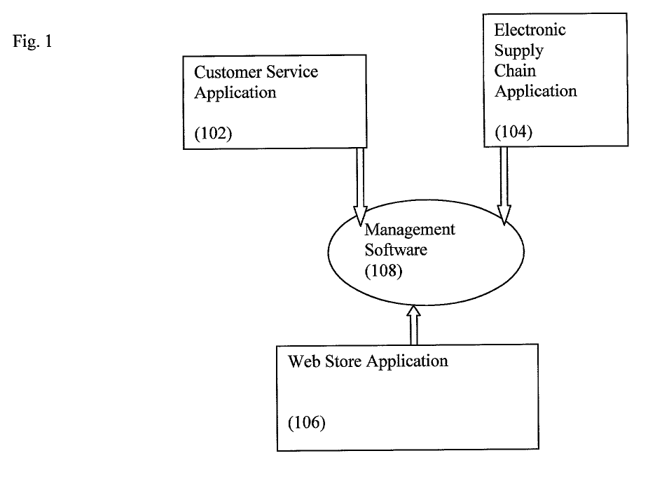

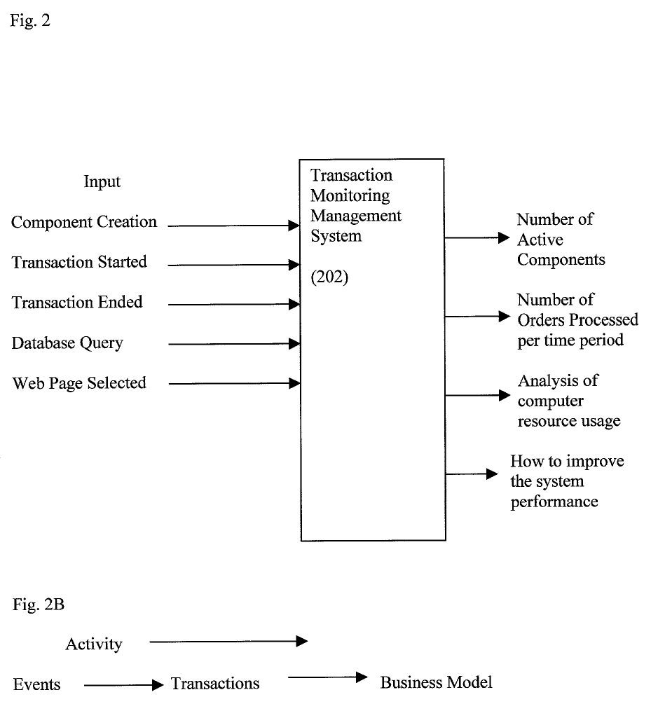

In particular, as shown in FIGS. 1 and 2, the invention can monitor the operation of existing, unmodified Web store applications 106, customer service applications 102 and electronic supply chain applications 104 (among other examples), and give IT managers, administrators and other users information about (for example) the number of active components in the applications and the number of orders processed per time period, as well as analysis of computer resource usage, and information on how to improve system performance. The system thus provides immediate, real-time information about the manager/user's business, not merely about the software applications, and forms a bridge between a physical, computational view of an e-commerce or other business-related software/hardware system, and a business view of that system. By correlating transactional performance and system performance over time, the invention can also draw a direct correlation between the computational limits and the business limits.

Referring now to FIG. 1, the drawing shows an example of the manner in which a management software application 108 using the transaction monitoring system of the invention can communicate with and help manage conventional customer service applications 102, electronic supply chain applications 104 and Web store applications 106. As shown, management software 108 using the transaction monitoring system of the invention can receive inputs from existing customer service applications 102, electronic supply chain applications 104, and Web store applications 106, and monitor transaction processing in the computers and applications software of the business.

Applications 102, 104 and 106 are merely examples of software applications that can be monitored by the present invention. They form no part of the present invention, and are shown simply to provide context for the present invention, a transaction monitoring system within management software 108. In addition, management software 108 may be otherwise essentially conventional in design and architecture, but suitable for integration of the transaction monitoring system of the invention. In particular, the transactional object systems typical of current e-commerce and other business computing systems contain components, which may work together to accomplish a common result (such as an online banking transaction, airline reservation or consumer purchase). Within such systems, each component's transactional objects emit Events, representative of specific state transitions or other significant occurrences. The invention exploits this behavior of existing systems, by using the Events as a way to intercept or “hook into” (in a non-intrusive manner) actions to and from the application's components. An important advantage of the invention is that the source code for the application built from these transactional objects need not be modified—the application as already configured will emit a stream of state transitions or significant occurrences that can be mapped into Events.

Given this behavior of transactional object systems, FIG. 2 depicts exemplary inputs and outputs of the transaction monitoring system of the invention, within the management software 108 of FIG. 1. The inputs shown in FIG. 2 are examples of those that might be generated by the customer service applications 102, electronic supply chain applications 104 and Web store applications 106 of FIG. 1. As shown in FIG. 2, the inputs to the invention's transaction monitoring system 202 include data representative of component creation, Transaction Start, Transaction End, database query and Web Page Selected. The outputs of transaction monitoring system 202 include: number of active components, number of orders processed per time period, analysis of computer resource usage, and information on how to improve system performance.

Thus, the invention tracks and collects low-level events and system information, such as when a component was created, when a Transaction begins, when a Transaction ends, when database queries occur, and the selection of Web pages. In turn, a Transaction can be defined as a single operational sequence performed on behalf of a particular user. The Transaction may be comprised of many steps, but all the individual steps can be analyzed as a single unit of work. Transactions are important to the description of the business, since they define the interaction of the business with entities both internal and external to the business. The transaction monitoring management software 202 correlates and analyzes this information, and uses it to describe how the application is running, not only in technical terms, but in business terms as well. The system also enables diagnosis and correction of problems, and provides business managers, administrators and other users, with an overview of system performance.

FIG. 2B illustrates the relationship between Events, Transactions, Activities and the Business Model in the transaction monitoring system 202 of FIG. 2. As shown therein (and explained in detail in the following sections of this document), the invention monitors raw system Events, correlates or maps them to form a description for respective Transaction instances, and then correlates sets of Transactions into a Business Model or Business View. Thus, the monitoring system of the invention constructs a business view (not merely a software view) of the business computing system. The overview provided may include the number of active components, the number of orders processed during a given time period, an analysis of resource usage, diagnosis and correction of system problems, and suggestions on how to enhance system performance. To provide this information, key features and operations of the invention include the correlation of Events (hereinafter referred to as “Event Correlation”), which in turn includes the construction and assignment of Transaction Names to sets of Events. (In effect, the monitoring system examines Events, determines which of the many Events belong to a given Transaction, and assigns a Business Name to each Transaction.) A key component of the system is the Event Factory (described in detail below), which processes Events. As also shown in FIG. 2B, transactions execute within the context of a logical processing system activity, and thus the Activity construct is a basis for describing monitoring system operations in the following discussion.

Banking System Example

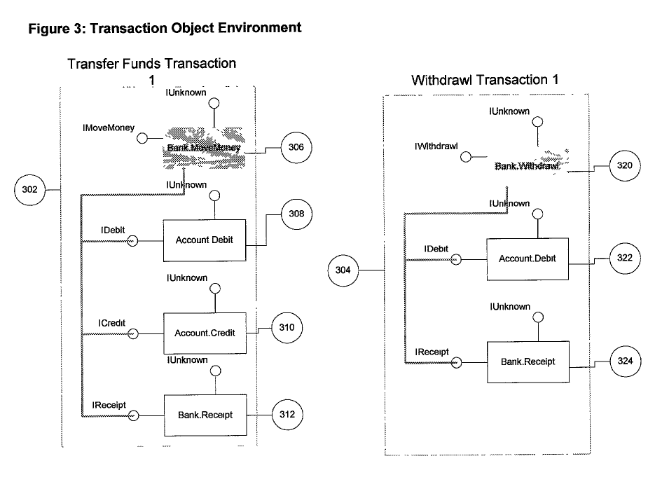

FIG. 3 shows how the monitoring system collects and processes Events in the context of an online banking system, and provides an example of how Transactions comprise the “building blocks” of Events, using the examples of the banking system's Funds Transfer Transaction 302 and Withdrawal Transaction 304. FIG. 3 is also an example of Transaction Object Events, which will be described in greater detail below, including three components of Transaction Creation, Sub-Component Creation, and Method Invocation. As shown in FIG. 3, the process flow of the Funds Transfer Transaction 302 includes Bank.MoveMoney event 306, Account.Debit event 308, Account.Credit event 310, and Bank.Receipt event 312. In turn, Withdrawal Transaction 304 comprises Bank.Withdrawal event 320, Account.Debit event 322 and Bank.Receipt event 324. It is contemplated that the monitoring system of the invention will be applied to substantially unmodified online banking and other e-commerce business systems, monitoring Events, correlating them into Transactions, and correlating the Transactions into Business Views (complete with metrics and other information about business and system performance), as described in the following sections of this document.

State Transitions and Events

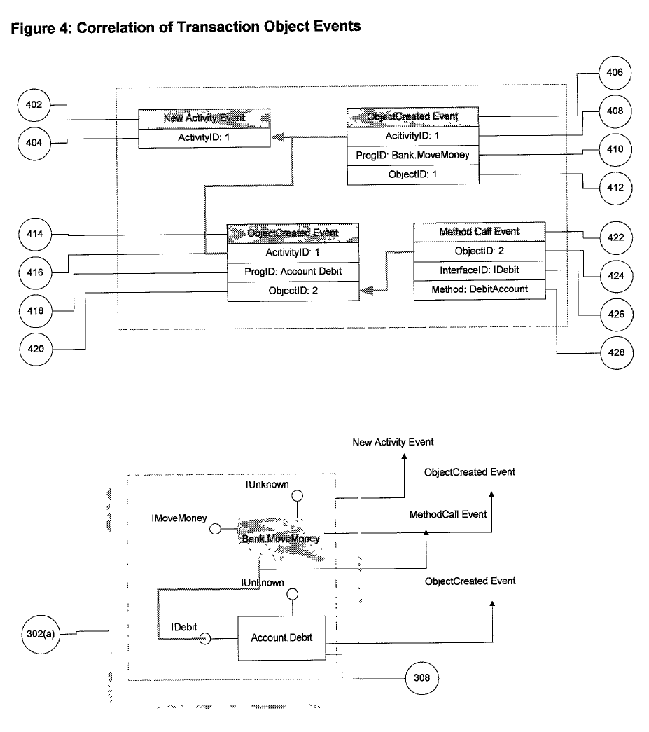

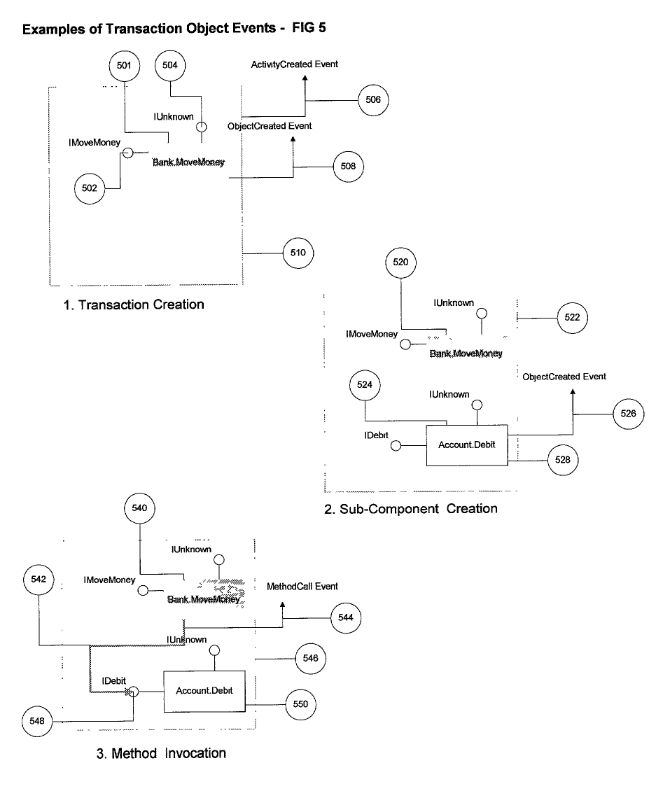

In order to arrive at the point where the components of the application are in the state depicted in FIG. 3, the transactional, component middleware (an existing, conventional part of the application being monitored) must go through numerous state transitions, processes that may be described with reference to FIGS. 4 and 5. This aspect of the system relates generally to that category of software referred to as Transactional Object Middleware. Examples of Transactional Object Middleware are described in documentation published by Microsoft Corporation and others, in connection with the Microsoft Transaction Server and COM+ Transaction Services (see Windows 2000 COM+ transactional middleware). The middleware treats each state transition as a significant event and emits a System Event with the type of transition and data about the transition. Three characteristic state transitions and the System Events emitted by the Middleware are shown in FIG. 5. The first (FIG. 5, module 1) shows a component Bank.MoveMoney being (501) created. Before the component can be created, the middleware must first create an execution context to run the component (510), referred to as an Activity. The creation of the Activity is itself a significant state transition, so a “ActivityCreated” event is emitted (506). Once the Activity is created, the system can then create the component instance (referred to herein as an Object) and the system emits an “ObjectCreated” event (508).

Not all components require the creation of an entirely new activation context. Those skilled in the art will recognize that it is typically desirable to associate many component instances in a single activation context to create a single logical thread of execution. Thus, the middleware can be instructed to create new component instances within an existing activation context. For example, FIG. 5, module 2, shows an Account.Debit component instance (520) being created in the existing execution context (522). This context (522) is the same context as created in FIG. 5, module 1 (510), and thus there is no need for another ActivityCreated event. The only System Event emitted is another ObjectCreated event (526).

It will also be understood that the components do not perform the work of the system, in and of themselves. It is the Method Calls between them that create the logical execution thread (as in FIG. 5, module 3). For example, code executing in the Bank.MoveMoney (540) object has a reference to the Account.Debit object's (550) Idebit interface (548). The interface is comprised of one or more methods, and the code in Bank.MoveMoney (540) calls one of those methods (542). A third kind of event, “MethodCall”, is emitted (544) by the middleware in response to the invocation of the method call.

Referring now to FIG. 4, there is shown the correlation of a portion of the Transaction Object Events that were shown in FIG. 3. The Bank.MoveMoney (306) and Account.Debit (308) events are shown in the box labeled 302(a) of FIG. 4. A Transaction begins with a new Activity Event 402, having an Activity ID=1 (404). The Transaction also may have one or more components. As shown in FIG. 4, the ObjectCreated Event 406 has an associated Activity ID=1 (408), which is the same throughout the Transaction; a ProgID (410) for the Bank.MoveMoney Event; and an ObjectID=1 (412). The next ObjectCreated Event (414) also has ActivityID=1 (416) and ProgID=Account.Debit (418), as it corresponds to the Account.Debit event. The Object ID=2 (420) for this event. The next Event is a Method Call Event (422), with Object ID=2 (424). This Event has an InterfaceID: Idebit (426) and Method: DebitAccount (428).

Transaction Object Environment

The Events from such a transactional object application describe the functioning of the application and contain semantic information about the functions being performed by the application. Each Event carries many pieces of data, called Event Data, such as what the Event represents and/or data values further identifying the operation that generated the event. It is not only the data within each event that is significant; it is also the order in which the Events are generated that defines the specific Event Stream.

Event Correlation is the process of taking an Event Stream and passing it through a series of algorithms to associate events to one another. For example, the start of a database transaction may be initiated with one Event and the end of that transaction with another. The system must match the specific Start and End Events to construct the proper metrics. Thus, for example, FIG. 4 depicts correlation of Transaction Object Events relating to the examples of FIG. 5.

A computer system in accordance with the invention can handle an arbitrary Event Stream. In this context, Event Correlation consists of a set of Agents or Probes (discussed in detail hereinafter) that capture the low-level System Events. Each Event is uniquely identified in the system and all of the Event Data for each Event is captured and associated with the Event. The system handles each Event abstractly so that it does not need to know the specifics of the Event or its Event Data. Instead, the system has the ability to be given algorithmic descriptions of how each Event is to be processed. Each collection of these algorithmic descriptions constitutes a unique form of analysis.

Thus, Transactions are formed through Event Correlation of a set of Events. These Transactions form the set of actual business functions taking place on the computer system. The business can then be modeled by understanding the model described by these Transactions and their attributes, such as their names, and how often, how long and in what proportion they execute. A computer system in accordance with the invention builds this model and presents it to the user as a description of the users business.

An example of an algorithm used in the presently described system is an algorithm for constructing general health metrics for business transactions for Microsoft Transaction Server and COM+ Transaction Services. This aspect of the system relates generally to that category of software referred to as Transactional Object Middleware.

Health Monitoring Metrics represent one kind of analysis that is of interest for business transactions. While Health Monitoring provides a general sense of system health and as applied to business transactions, it is important to understand how the transaction is defined in terms of the Event Stream and then what metrics are collected.

A Transaction, as defined herein, is a logical unit of work constructed from the information in the Event Stream. The Transaction has a Start and an End. The time difference between the Start and the End of the Transaction represents the total duration; and the duration of a Transaction is one metric of the system. This algorithm describes how one determines the Start and End from the event stream. Equally important are the other pieces of work performed during the Transactions—these other pieces of work are described in the Event Stream and are used to produce other Transaction metrics.

The Transaction starts when a method on a Transaction Object is called from a non-transactional object (see “MethodCall Event” below). This first Transactional Object is called the “Root Object”. The methods for this Root Object represent the business functions and thus the system uses the method names to create the initial mapping from Event data to Business Transaction.

Transactions execute within the context of a logical Activity. Thus, the first event is the event that describes the beginning of the Activity. In accordance with the invention, the ActivityBegin Event provides the ActivityID. This ActivityID is recorded and stored for retrieval by its ActivityID.

The Activity was created for purposes of creating the root object. All transactional object creations are defined by an ObjectCreate Event. The ObjectCreate Event contains the ActivityID for which this Object is being created. Through the ActivityID, the Root Object is correlated to Activity. The specific Root Object is identified by a unique ObjectID.

At some later time, the client of the Root Object calls one of the Root Object's Methods. At this point the Transaction starts. The Method Call is identified with a MethodCall Event. The MethodCall Event contains the ObjectID which allows us to correlate all method calls back to the object and implicitly the activity. The transaction begins and the start time is recorded.

Calling the Method could result in any amount of work, including more Method Calls and/or other subordinate objects being created. Additional Events, which are correlated to the Activity, can follow.

The Transaction ends when the Root Object returns from the Method Call starting the Transaction. At that point the time of the MethodReturn Event is recorded and used to calculate the Transaction Duration metric. The Activity may or may not end at that point. If the client calling the Root Object releases the Root Object, the Activity ends. If not, the Activity remains active and it is possible that the client will call the same or another Method.

Each call to the Root Object's method results in the recording of a single Transaction. Metrics such as the duration and what subsequent resources involved are records and included in the information kept about this single Transaction. The set of Transactions of this type form yet another metric when evaluated over time as well the frequency of activation and the total number. Finally, the set of all distinct Transaction types creates yet another metric of interest to the business as the proportion of each distinct Transaction type forms the basis for the model describing the business.

It will be appreciated that there are many other metrics that can be used to describe a business view, such as an activity that describes how long a client is active in the system and also who that client is (which we know from other events).

Details for Associating Transactions and Business Relevancy

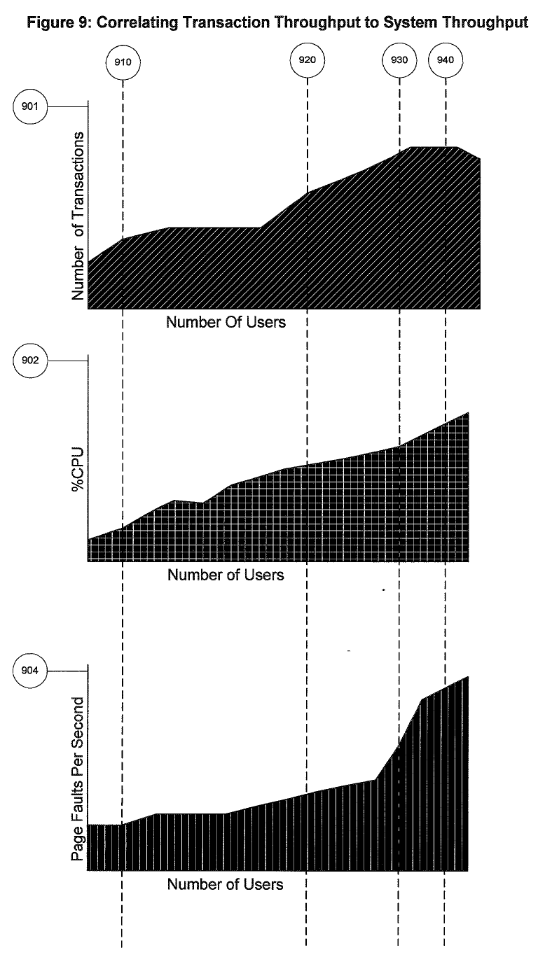

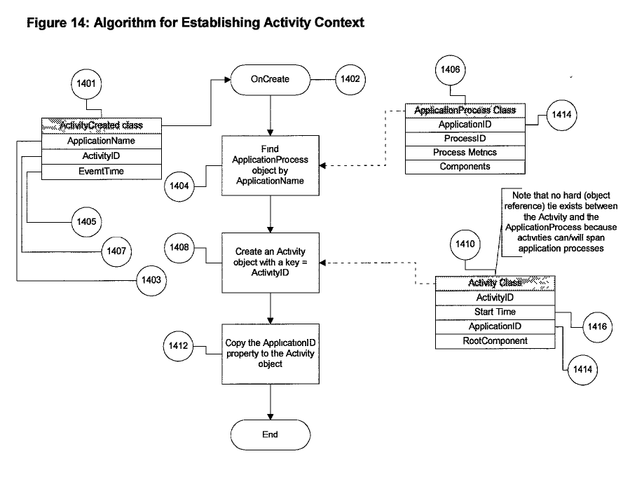

As stated in the introduction and example above, the collection of raw System Events can be correlated to form a description for a single Transaction instance (the details of which will be discussed below in connection with FIGS. 14-18); the set of Transaction instances is formed into a Transaction type (as discussed in connection with FIGS. 9 and 24); and then the set of Transaction types forms the Business Model. This Model describes the business in terms of the Transactions the business performs. Many details go into building the Model and its description of the business. The following section describes specific algorithms that can be used by the invention for creating and describing this model.

The process of building a model for business relevancy occurs on top of the algorithms within the invention for creating a single Transaction instance from the System Events. The algorithms for this part of the invention have been generally described above and will be fully described below. This section assumes that a well-formed Transaction instance has been created by the monitoring system and is available for use in processing.

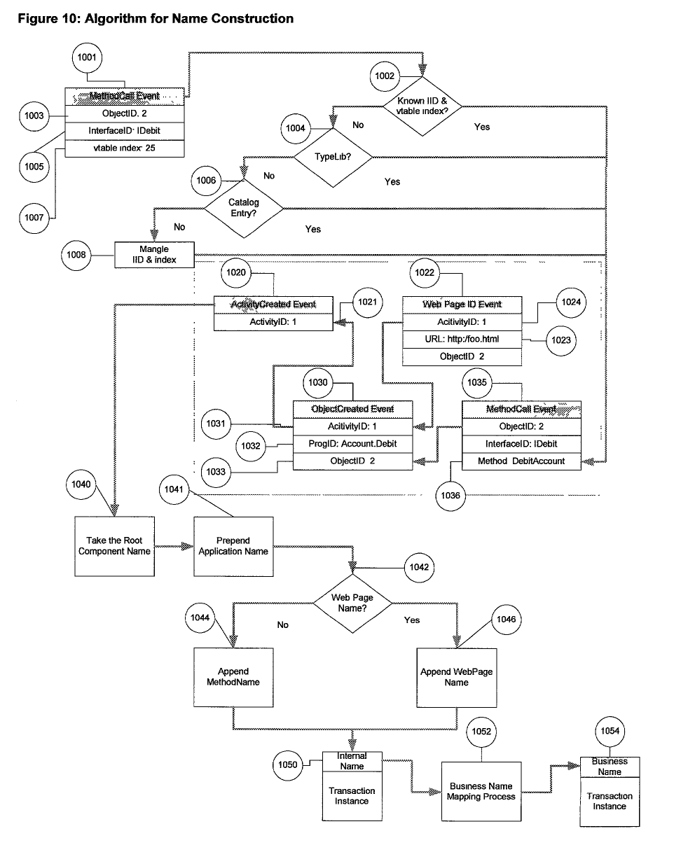

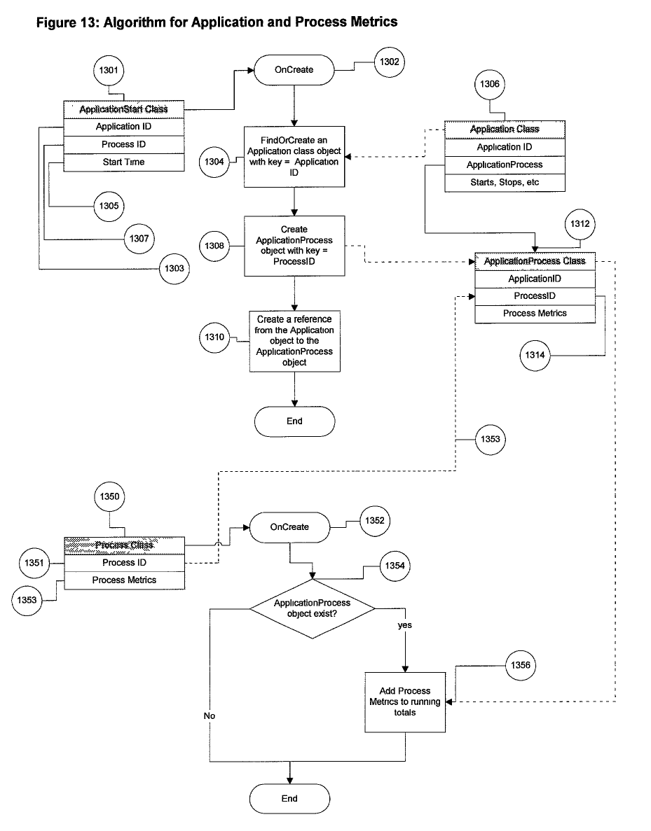

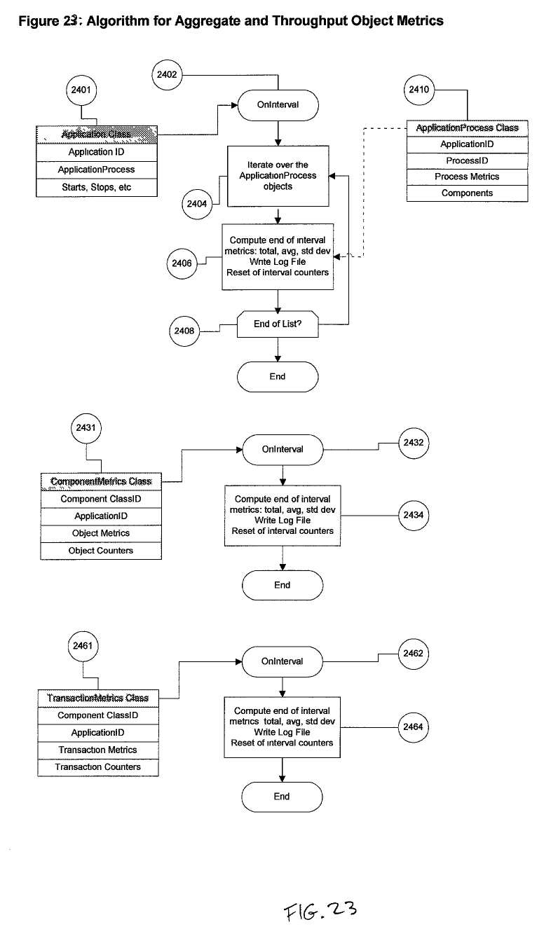

Building the set of metrics involves collecting the set of Transaction instances (see, e.g., FIG. 14, item 1410), naming of their types (see FIG. 10), computing rates over a specified interval (FIG. 23), and analyzing values of these intervals against long-term archived data. It is from this foundation of information that the model of the business is created. Finally, these metrics are mapped against time correlated system performance information to construct cost factors and constraint metrics (FIG. 13). Adding the system performance metrics completes the model because now the capacity of the computer systems is known and can be directly mapped to the business capacity in terms of the Transaction Model.

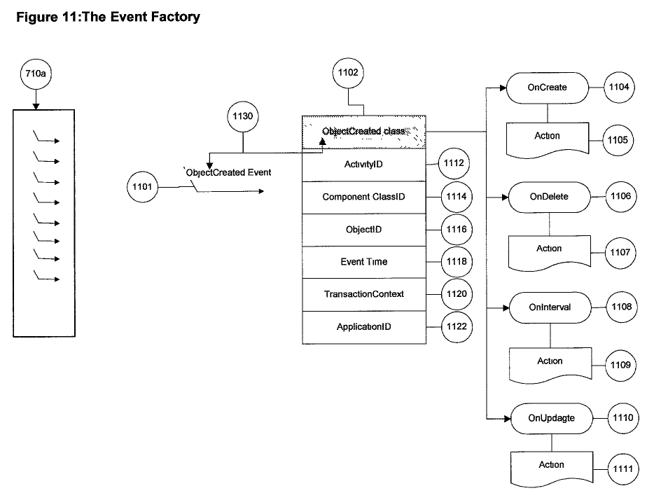

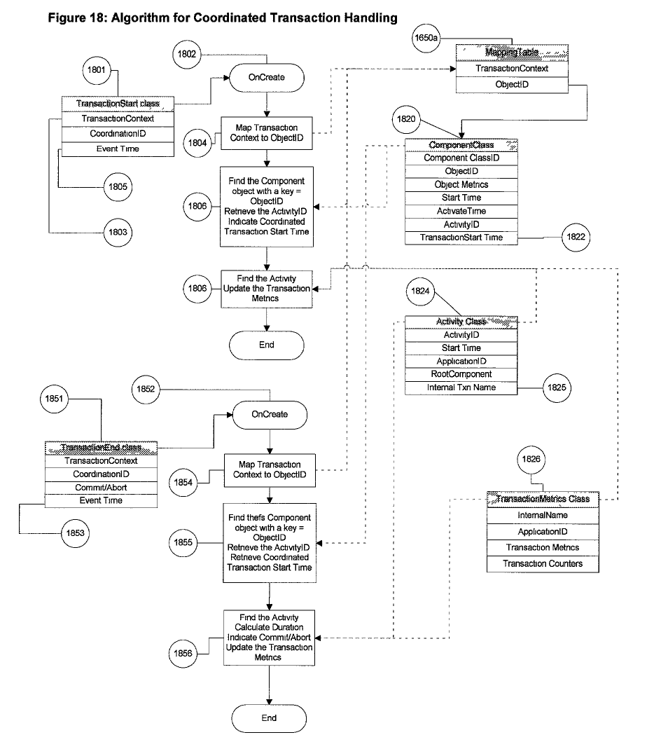

As described in greater detail below, System Events are processed in the Event Factory (FIG. 11) according to the algorithms described for FIGS. 14-18. These algorithms describe how individual Transaction instances are derived from the System Events Aggregate metrics for transactions of the same name are also collected (FIG. 18, items 1826, 1856). Once per Event Factory interval, the aggregate metrics are processed (FIG. 23, item 2461). Collecting the set of Transaction instances (FIGS. 14-18) and naming their types are separate operations (FIG. 10), but are intimately tied, since the Name represents the main index for partitioning the Transaction instances. In the process of sorting the Transaction instances and collecting the aggregate metrics, Business Naming is associated with the internally named Transaction instances (FIG. 10, item 1052), resulting in a Transaction named with business relevancy (FIG. 10, item 1054). The application of the name at this point and in this fashion is effected to maximize efficiency of operation.

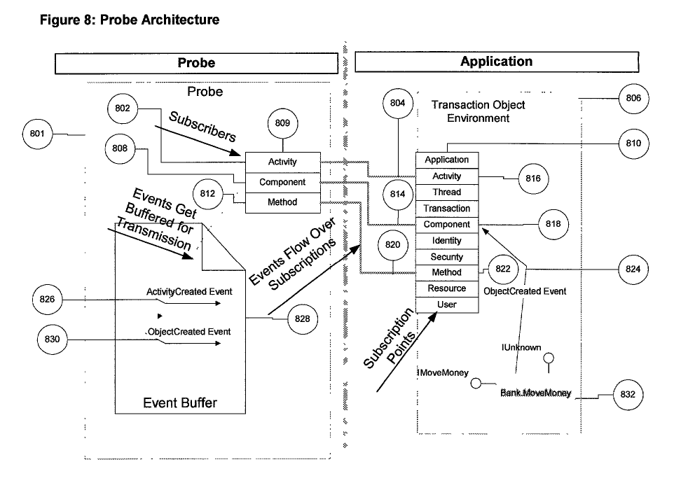

The foregoing describes aspects of Event Correlation, but not the actual mechanisms for achieving the correlation. These will next be discussed. A central aspect of the invention in executing Event Correlation is the “Event Factory”, which will be discussed in detail below in connection with Event Correlation detail (FIGS. 8-11). A significant point, however, is that a single Event Factory is used uniformly and recursively throughout the system. Thus, the aspects of combining the Transactions instances into sets and naming these with Business Names (i.e., labels correcting to a Business View), is simply a practice of Event Correlation.

Transaction Naming

The process of naming a Transaction occurs in a three-phase process, shown in FIG. 10. Given the recursive nature of the Event Factory, the first two phases of the work are done during the correlation of the System Events. Transforming the name into one that is understandable to a business user is part of the correlation process. The sequence of algorithms used to construct the Transaction name is specified separately to provide additional clarity. FIG. 10 depicts the algorithm for constructing the name of the Transaction based on values available in the System Events combined into a Transaction instance. These values are extracted from the System Event data during the processing of the System Event. All three phases of name construction are depicted as a single, contiguous flow in the diagram, even though there is some discontinuity in terms of execution times due to the nature of the Event Factory's processing.

Referring now to FIG. 10, four System Events are used in constructing the Transaction Name: ActivityCreated (1020), Web Page ID (1022), ComponentCreated (1030), and MethodCall (1035). The MethodCall Event requires some additional processing beyond the raw data. Specifically, the method name (1036) must be constructed from the other data in the raw System Event (1001). When a MethodCall event is detected, the invention checks to see if this IID and method index pair are already known (1002). If so, the name is returned (1036). If not, then if there is object type information known for this component (1004), then the IID and method index are looked up in the object type information and returned (1036). Without specific object type information, the global object type catalog kept by the transactional object middleware system is checked (1006) and if found, the name is returned (1036). If all of these attempts fail, then the name is constructed from the by mangling the IDD and method index (1008) and returned (1036).

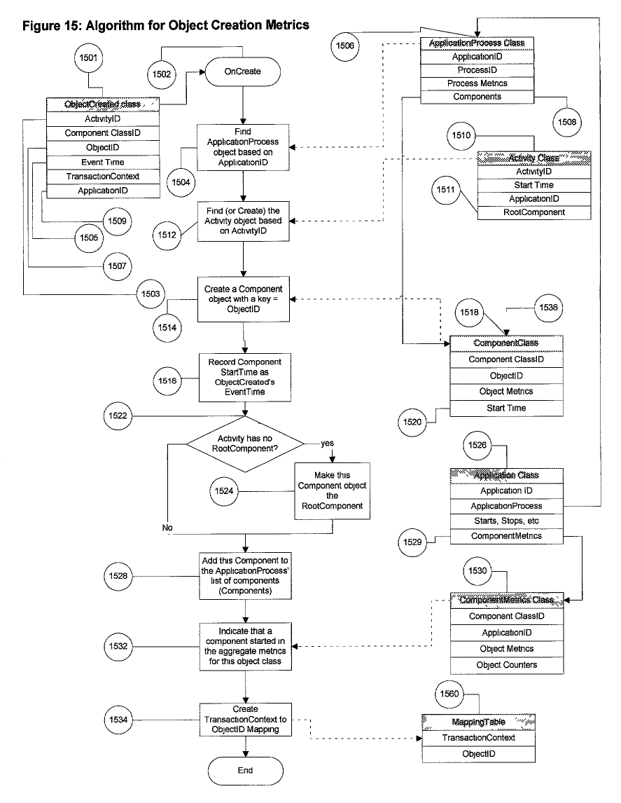

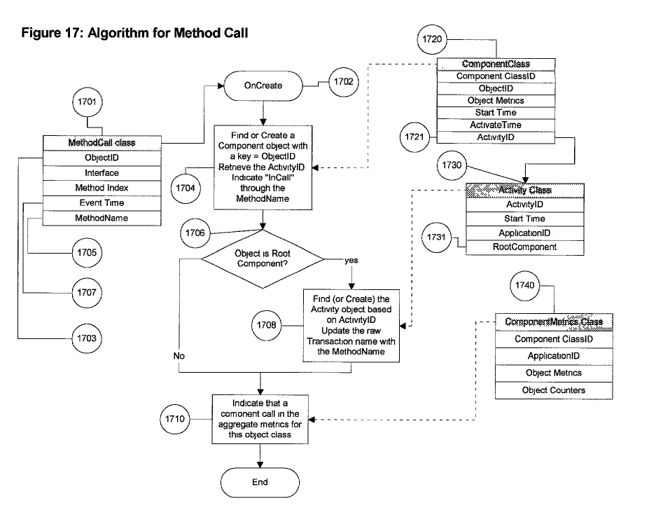

When the MethodCall Event is processed by the Event Factory, the Method's Name is used to construct the name of the transaction (as described below in connection with FIG. 17, item 1708). At the base of the Name is the “Root Component” Name (1040). The Root Component is calculated when the ObjectCreated Event is processed by the Event Factory (FIG. 15). The Application Name (FIG. 13) is prepended (1041). If there is a Web Page ID event (1042), then the Web page name is used to further qualify the name, otherwise the Method Name is used (1044, 1046). This constructs the “Internal” Transaction Name (1050). This internal name is then processed by the Business Name Mapping Process (1052) and the result is a Transaction named with business relevancy (1054).

In terms of Transactions, the system has now successfully calculated all of the important metrics for Transaction instances (described further in connection with FIGS. 14-18), created unique sets of Transactions (FIG. 18, items 1826, 1856) and by virtue of the interval calculated and saved the relative, aggregate metrics between the sets (FIG. 24, item 2464). The result is a Transactional Model for the business. Adding in the fact that all of the Transactions are identified by business relevant names (1054), the result is a Transactional, Business View. All that is left is to understand the capacity of this “logical” model against the physical, computational resources required to execute this capacity, which will next be described.

Event Factory

Referring now to FIGS. 9 and 11-13, at this point, the invention employs the Event Factory and a new set of System Events. These System Events are not about the transactional object middleware platform, but are generated from the operating system itself. The raw System Event data is needed to provide data about the actual process executing the transactional components (FIG. 13, items 1350, 1351, 1353) as well as a way to understand the correlation between the process (1307, 1314, 1351) and the System Events from the transactional object middleware platform (1312).

The System Event containing the actual process metrics is collected by the monitoring system of the present invention. System Calls are provided by the operating system to retrieve this information and an Event is constructed in the Event Factory to represent this (1350).

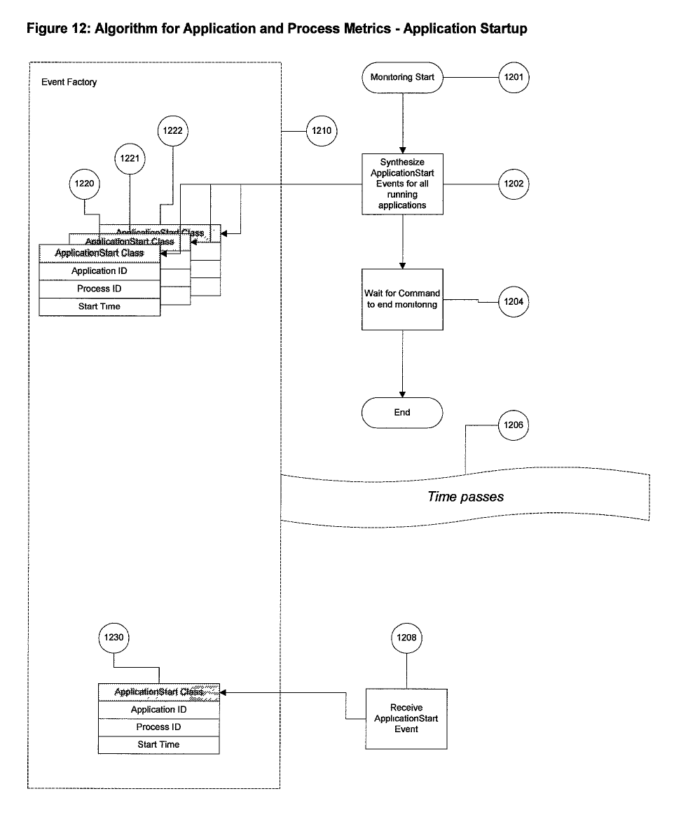

When these processes begin and end, must also be determined. The invention uses a number of different techniques to synthesize a System Event for process start, because the actual System Events from the transactional object middleware system are insufficient, in that the monitoring system may not be running when the application process starts. Thus, the methods of the invention are careful to create events at the proper time, but to not duplicate the actual events. The invention compensates for these cases using algorithms described in FIG. 12 to create an environment where the beginning of a process is known to the invention.

The existence of reliable events that relay the information about process creation and termination with respect to the components in the transactional component middleware system is crucial, because these events form the bridge between the business view of the system and the physical, computational view. The other important correlation metric is the number of users. At a given number of users, the number of Transaction executing within a system is determined using some fixed amount of system resources. By correlating the system performance and the Transactional performance over time we draw a direct correlation between the computational limits and the business limits.

For purposes of a transactional component middleware system, the relevant metrics that must be correlated are CPU utilization, page fault rate, virtual memory size and number of threads. These metrics are relevant because the transactional component middleware resides only in memory and these are the ones that will bottleneck the computer system. Thus, at the point that in which these system parameters create a system bottleneck, the Transactional model is at its maximum capacity (for this configuration).

For example, FIG. 9 shows the Number of Transactions (901), CPU Utilization (902) and Page Fault Rate (904) aligned by the number of users in a system of the type in which the present invention might operate. Data points 910, 920, and 930 show linear growth with the number of users. Data points 930 to 940 show a plateau in terms of growth in number of transactions. This can be accounted by the asymptotic growth of the page fault rate between those points. By inference, it is at this point that the Transactional, Business Model is at its theoretical maximum value. This is the point at which the monitoring system might indicate to a system manager/administrator that additional resources might be necessary to handle additional business.

At this point, since we have a model that is in business terms and directly co-relatable to system performance, we can choose to report only the business view of the computer system. While the computational view is important to some classes of users, other classes of users will want to understand their computer system simply in terms of how much business processing is occurring.

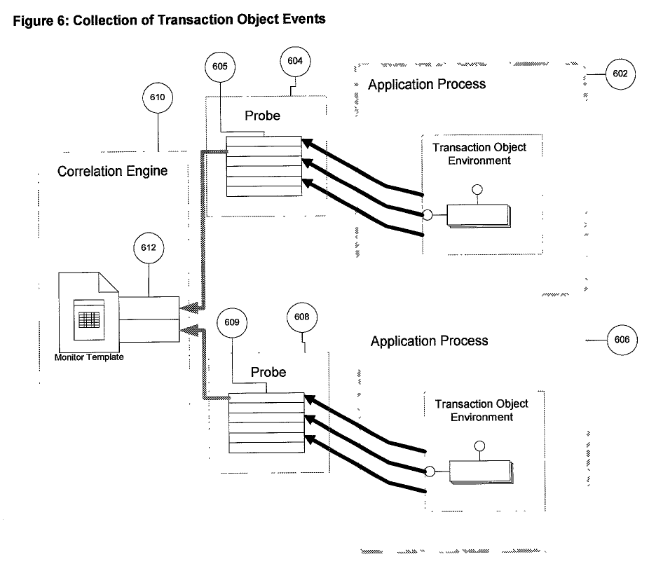

Having described in higher-level terms the operation and functions of the invention, the following sections provide detail of the methods and modules described herein, with reference to FIGS. 6-8, beginning with Probes, System Event Correlation and the Event Factory.

Details for System Event Correlation and Event Factory

At the lowest level of the system, the Probe architecture is responsible for connecting into the computer system's transactional object middleware and requesting System Events. The way in which this is done is defined by transactional object middleware (an aspect which in all likelihood has already been established by the existing transactional object middleware of the e-commerce business system). The monitoring system of the invention, as a general matter, should follow this existing protocol for subscribing to these events, to thereby achieve its aim of non-intrusive monitoring. Thus, each Event is collected and its values are retained in a buffer of other events. Referring this time to FIG. 8, the disclosed system uses an ObjectCreated Event as an example of how the Probe architecture works in accordance with the system described herein.

The transactional, object middleware system provides an overall context in which component instances run, as well as a number of services to the component instances and the outside world. One such service is the publishing of state transitions in the form of a set of System Events. The System Events can be “subscribed”, based on the Types of Event. As shown in FIG. 8, the middleware defines the set of System Events, the set of Subscription Points (810), and the full set of events available (810). A Probe has a set of events that must be subscribed (809) to complete the analysis. The Subscriptions (804, 814, 820) are provided to middleware system that delivers any event of a specific type (816, 818, 822) to the Probe's Handlers (802, 808, 812).

In the example, a new Component Instance of Bank.MoveMoney (832) is created and an ObjectCreated Event (824) is generated within the Transactional Object Enviromnent (806). The Component Event Subscription Point (818) knows that the Probe has subscribed to this set of Events and passes the Event to the Probe's Handler (808). The Probe receives the event and copies the event data (830) to the current buffer of events (828). The buffer stores events in groups as a way of reducing the transmission cost of a single event. In the example, the event buffer has already received the ActivityCreated Event that the middleware passed to the Probe's Activity event handler (802, 804, 816).

Collection and Correlation Mechanisms

As previously described, the work of building a business view of a computer system requires a collection and correlation system to process the Events, which are in turn re-processed into the Business View. Such a system ideally includes a Probe mechanism that defines how System Events are extracted from the system, a Collection mechanism for combining System Events from more than one application process, and a Correlation mechanism that performs the acts that relate one System Event to another and can combine them to produce useful information.

FIG. 6 depicts the relationships of the distinct parts of the Collection and Correlation mechanisms of the system described herein. As shown in FIG. 6, a first application process 602 generates Events, which are collected by Probe 604 into an Event Buffer 605. A second application process 606 also generates Events. Likewise, Probe 608 detects Events whenever they occur in the second application, and stores the detected Events in a second Event Buffer 609. The Event Data Values corresponding to the event, including the application that generated the Event, and the time of the Event generation, are also collected and stored with the Event in the appropriate Event Buffer. The Events from the two Event Buffers 604, 608 are then combined by Correlation Engine 610. The Correlation Engine 610 orders the events in a Correlation Buffer 612, according to the time of the event generation.

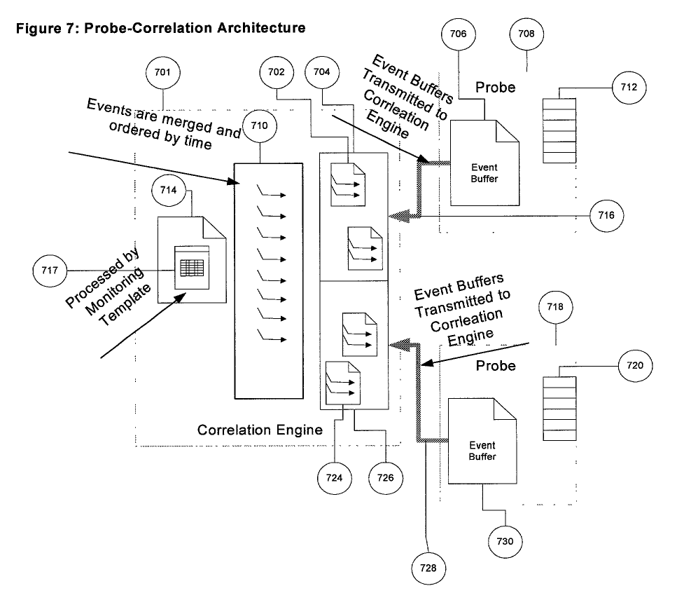

FIG. 7 shows additional detail of the inner workings of the Probe Mechanism (708, 718) and how it is combined with the Correlation Engine (701) to produce a system capable of high volumes of system events. The parts of the Probe in FIG. 7 (708 and 712, 718 and 720) correspond to the same parts of the system depicted in FIG. 6 (604, 605, 608 and 609). The additional detail of an Event Buffer is added to FIG. 7 to indicate that System Events are collected into “batches” before being sent to the Correlation Engine (716, 728). The buffers from each Probe are then collected in the Correlation Engine (704, 726) along with buffers from the same Probe that have been sent by the Probe, but not yet processed by the Correlation Engine (702, 724). The Correlation Engine takes these buffers (702, 724) and merges them into a single buffer (710) and ordered by the time of the event. The correlation mechanism contains a set of Correlation Algorithms (714) and an engine for executing the code describing the algorithms.

Two sets of algorithms are used to correlate the System Event data into the Transaction instances used in calculating the business metrics of the computer system. The first set are those previously described, which describe a business in terms of its transactions. The second set describes how the raw set of System Events is converted into metrics about the application in terms of its Components, Transactions and Methods. These algorithms are most easily described in terms of how they are solved using the part of the Correlation Engine called the Event Factory (714 of FIG. 7). In the illustrated embodiments, the Event Factory is the heart of the Correlation Engine, and provides the processing model for all correlations and analysis. There is no requirement imposed by the invention to use the Event Factory to solve the problem of correlating the System Events—it is merely a way of describing the algorithms.

Event Factory

The Event Factory is thus the “engine” that executes the descriptions of the algorithms. In addition, a preferred practice of the system employs a “template”, i.e., the collection of all the analyses that logically fit together. These templates can share analyses, such as the one for the Transactions described above. FIG. 7 shows (at 717 et al.) the relationship of the template to the overall system. Among other functions, the Event Factory combines the ordered System Events with the monitoring template. These functions will be described in greater detail below.

Event Factory Programming Model

Two aspects of the Event Factory are central to its function: the Programming Model and the Event Factory's services to support the Programming Model. Among these, the Programming Model describes how Templates define their analyses, while the services provide runtime support for utilitarian functions to support the Programming Model. The Programming Model for the Event Factory is relatively simple. Everything is represented as by a class and each instance is a special kind of Object—i.e., a Factory Object (not a Transactional Object). Programming of the Event Factory involves programming State Transactions of the Factory Object classes: creation (see OnCreate—1104 of FIG. 11), termination (OnDelete—1106 of FIG. 11), monitoring interval expiration (OnInterval—1108 of FIG. 11), and when a dependent Factory Object is created (OnUpdate—1110 of FIG. 11). Factory Objects contain data that are referenced as Factory Object properties (1112, 1114, 1116, 1118, 1120, 1122 of FIG. 11). At any (or all) of the State Transactions, program code can be attached to run (1105, 1107, 1109, 1111 of FIG. 11). The program code can be written using any programming language or scripting language. These pieces of code attached to the State Transitions are called “Actions”.

The services provided by the Event Factory support the Actions and provide communication between the Factory Object and the Object Factory. The services provided by the factory control object lifetime, provide information about Factory Objects, find other Factory Objects, define/remove Factory Object metadata, and calculate metrics for common calculations (such as standard deviation).

Referring again to FIG. 11, after the System Events from the Event Buffers are ordered by time (710a), each System Event is processed (1101) and a Factory Object representing it is created in the Event Factory (1102). There is a one-to-one mapping between System Event types and Factory Object classes—i.e., an ObjectCreated event has an ObjectCreated Factory Object instance created (1130). All of the data values from the Event are copied into the Factory Object's properties.

When this ObjectCreate Factory Object is created, the Event Factory runs the action associated with OnCreate. For example, the creation action might create another Factory Object of class ObjectTracker. The ObjectTracker class might record the Start time and a unique identifier for the object from the original ObjectCreate Factory Object. Later, when an Object is deleted, there is an object deleted System Event. This in turn causes the creation of an ObjectDeleted Factory Object. The OnCreate action for the ObjectDeleted class specifies that the Event Factory lookup an ObjectTracker Object with the Object Identifier identified by the Event. The Action would then store the time that the Object was deleted in the ObjectTracker object, and then delete the ObjectTracker Object. Deleting the ObjectTracker Object causes the Event Factory to execute any OnDelete Actions. Such an Action might calculate the elapsed time that the Object was active and log the resulting metric to a log file.

The foregoing is an example of how the Event Factory can be programmed. The system described herein can program the Event Factory with more complex algorithms for generating metrics about the performance of transactional components, and ultimately the business transactions, as described above. The significant point is that the Event Factory has an inherent mechanism for building up layers of Factory Objects representing a state of the application. The System Events emitted by the transactional component middleware are the lowest level (rawest) Events. These Events are represented in the Event Factory as Factory Objects that in turn create other Factory Objects. These second level Factory Objects can, in turn, create a third level, and so forth. Thus, the Object Classes represent layers of abstraction. All of these Objects are Factory Objects and processed uniformly by the Event Factory.

This programming model simplifies the expression of the processing algorithms. However, it is worth noting that the sequence of System Events is not ordered by anything other than time. Thus, Events for one interaction are intertwined with events of other interactions. For example, the first Event may be that Object1 was created, the next that a Method was called on Object1, then a second Object, Object2, was created, then the Method Call for Object1 returned, then Object3 was created, and so on. As a result of this “hash” of events, the event stream cannot be processed in a pure, linear fashion. Instead, the algorithms are sets of small bits of linear processing for each state transition of a Factory Object.

Of equal importance is the data associated with each event. Referring, for example, to FIG. 4, that drawing graphically depicts the data relationships between Events. However, FIG. 4 shows only a subset of the data (those that were important to show the relationships). An actual set of events is much broader (there are more events) as well as richer (each event contains more data). An example of such an event set can be found in the Microsoft Windows 2000 Platform SDK. The Windows 2000 COM+ transactional middleware provides a set of Events as described herein.

For purposes of clarity, the algorithms describing Event Correlation and Metric Generation are discussed using Factory Object classes rather than System Events. Also, not all of the class properties are illustrated in the algorithms. Some class properties are used by the Event Factory for bookkeeping or for storing cached results that do not affect the results of the algorithm.

Algorithms for Application and Process Creation Metrics:

Those skilled in the art will appreciate that applications are composed of one or more processes. Because components reside within application processes, it is important for the system to be cognizant of the processes. Application processes are also significant because they have system level performance metrics that are correlated against the component and transactional metrics. Accordingly, the monitoring system of the invention takes special care to create the proper state(s) in the Event Factory to describe application processes.

Normally, when an application process starts, the transactional object middleware (e.g., commercially available Microsoft Windows 2000 COM+ transactional object middleware) sends a System Event indicating that an application process has been created. Through the normal Event Factory mechanisms, this event is turned into a Factory Object—in this instance, of class ApplicationStart. How, then, to account for application processes that start prior to the start-up of the monitoring system? In this instance, the monitoring system looks for and finds all currently running application processes, and creates a Factory Object of class ApplicationStart for each of these currently running application processes. FIG. 12 illustrates these two conditions for creation of ApplicationStart objects.

As shown in FIG. 12, when the invention begins monitoring (1201), through system startup or a user action, the invention queries the transactional object middleware for a list of running application processes (1202). For each running application process, the invention creates Event Factory (1210) ApplicationStart Objects (1220, 1221, 1222). These ApplicationStart objects are identical to the ones created by the invention as a result of Application Start System Event. The invention performs other initializations and then waits for a command from the system to shut itself down (1204).

At any subsequent time (1206), while the invention is waiting for the command to shut itself down, other application processes may be created as users run new applications. The transactional object middleware responds (an existing transactional object middleware function) by creating an Application Start System Event, which the invention collects (1208). Here too, an ApplicationStart Object is created (1230) in the Event Factory (1210).

The ApplicationStart object has an OnCreate action (FIG. 13, items 1301 and 1302) that looks for an Application Object (1306) with a key value equal to its ApplicationID property (1303). If one does not exist, a new one is created (1304). It then creates an ApplicationProcess Object (1312) using its ProcessID property (1307) as the key (1306). Other information such as the ApplicationID and the process creation time is stored in the ApplicationProcess object. Finally, a reference to the ApplicationProcess Object is stored in the Application Object (1310).

The separation between Application and ApplicationProcess has at least two purposes. First, it allows the monitoring system to model multiple processes per application. Second, it provides a sound organizational metaphor to store application statistics that survive application process creation and deletion.

At regular intervals (not the Onlnterval interval), Process Objects are created in the Event Factory. A Process Object contains information about the physical process within the operating system such as CPU utilization, thread count and page faults. On Process Object's (1350) OnCreate (1352), the Action looks up the ApplicationProcess Object that matches the ProcessID (1353). If such an ApplicationProcess Object exists (1354), the Action updates the ApplicationProcess object's (1312) metrics by adding the values in the Process object into those of the ApplicationProcess (1356).

Algorithms for Obiect Creation Metrics:

To properly understand and compute metrics for objects (components), the monitoring system of the invention must first handle “Activity” objects. An “Activity” is a logical thread of execution that crosses objects and computers, so that a single calling sequence can be traced in a distributed environment. This Activity forms the backbone of the Transaction Metrics (described below). FIG. 14 shows the collection and handling of ActivityCreated Objects (1401) as a precursor to handling ObjectCreated Events. Here the invention creates Activity Objects (1410) that hold state and provide context for handling ObjectCreated Objects. Note that the Activity Object (1410) is not directly linked to an ApplicationProcess (1406) because an activity can span multiple application processes.

The ActivityCreated Object's (1401) OnCreate action (1402) fires when an ActivityCreated Object (1401) is created in the EventFactory. This is the result of an Activity Created System Event. Thus, as shown in FIG. 14, an Activity Object is created at 1408. The ApplicationProcess Object (1406) must be looked up, because the Activity Object (1410) wants to copy information such as the ApplicationID (1414) from the ApplicationProcess Object (1412) to the Activity Object (1416). Similarly, the Event Time (1405) is copied from the ActivityCreated Object (1401) to the Activity Object's Start Time property (1414).

An ObjectCreated Object (1501) indicates that a new Object was created. An Object is assigned to an Activity through the ActivityID (1503) that is a unique identifier across the network. FIG. 15 describes the OnCreate action's (1502) algorithm for the ObjectCreated class (1501). Both the ApplicationProcess (1506) and the Activity (1510) Objects are retrieved (1504 and 1512). Some systems lack an explicit ActivityCreate event, so the lack of known Activity indicates that a new one should be created (1512). A Component Object (1518) is created to represent the Object just created. The Component Object is initialized (1516) with the Start Time of the Component Object (1520) coming from the Event Time of the ObjectCreated Object (1505). If this Activity doesn't already have a Root Component (1522), then this Object becomes the Root Component (1524). This association is represent as a reference (1536) in the Activity's RootComponent property (1511) to the Component object (1518).

The ApplicationProcess Object (1506) keeps a list of all instantiated Components; and a reference to the Component Object (1518) is stored in the ApplicationProcess' Components list (1508). The fact that an Object was created is a significant event to count (1518) and the Application Object (1526) holds a list of ComponentMetrics Objects (1529) (one for each Component class) where it keeps counts of creations, successful or failed terminations and averages for individual component metrics. Here too, the ComponentMetrics Object (1530) is dynamically created if this is the first Object of a particular Component Class. Finally, a mapping table entry (1560) is created (1534) associating a Component with any distributed, coordinated Transactions in which this Object participates through the TransactionContext property (1509). The mapping table entry is used by subsequent Transaction Objects that pass TransactionContext values and whose actions need to find the associated Object.

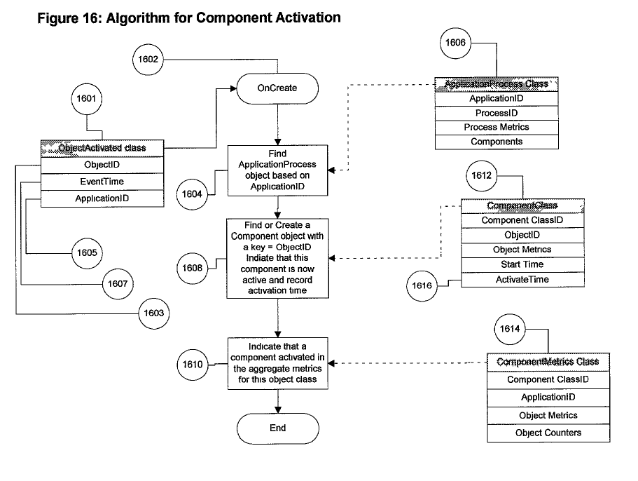

The last phase of Object Creation is activation of the Object. Activation means that the Object is fully created and resourced. The transactional object middleware will not activate an Object until it is actually needed. Objects may activate and deactivate many times over their lifetime—this is a feature of the transactional, component middleware. An ObjectActived object (FIG. 16, 1601) is created when an Object activates and the ObjectActived class' OnCreate action (1602) executes. The ApplicationID property (1605) from the ObjectActived Object is used to find the associated ApplicationProcess (1606). Through the ApplicationProcess, the proper Component Object (1612) is located. The Component Object is marked as Active (1606), and the ActivateTime (1616) is set from the Event Time (1607). Again, the proper ComponentMetrics Object (1614) is located and the aggregate counter values are updated to reflect the activated component (1610).

Algorithms for Method Call Metrics

Referring now to FIG. 17, Method Calls are processed for both the raw metrics of number of calls of each type (both number and rate), and duration. They also play an important part in giving business transactions Raw Names. When a MethodCall Object (1701) is created, the OnCreate Action (1702) executes. The Component Object (1720) that this method belongs to is found through the ObjectID property (1703). Retrieving the Component Object (1720) gives us the Object to store the method Event Time (1707) as well as giving us the ActivityID (1721). If this Component is the RootComponent (1731) of the Activity, then the Method's Name (1705) is used to further create the Activity's Raw Name.

FIG. 10 depicts the naming algorithm for the Raw Transaction Name, and includes in its definition the algorithm for deriving the Method's Name. In FIG. 10, item 1026 is the Object 1701 of FIG. 17. The Method (1027) produced by the first part of the algorithm in FIG. 10 is the value passed in the property 1705; and the name from internal transaction name (1050) is the name that is stored in the Activity.

In FIG. 17, the last step (1710) is to update the proper ComponentsMetrics Object (1740) with the information that there is another Object “on call”.

Algorithms for Transaction Coordination

Transaction Coordination is the process in which the transactional, component middleware participates with other resources, such as database management systems, in ACID (Atomic, Consistent, Isolated, Durable) Transactions. An external software entity acts as the coordinator to ensure that all participating members of the transaction are synchronized with regard to their updates. Within the transactional, component middleware system these coordination points are represented as events and indicate both where/when Transactions start.

The challenge presented is that the coordinated Transaction Events need to be associated back to the Components, but there is no Object information. The solution is as follows. In FIG. 15, there was disclosed a mapping table entry to map from a TransactionContext value to an ObjectID (1560). In FIG. 18, this mapping table entry is reference as 1560a. This Mapping Table maps the TransactionContext property (1805) in TransactionStart Object (1801) to the proper Component (1820) ObjectID. With ObjectID, the Component Object (1820) is found (1806) and the Coordinated Transaction Start Time is recorded (1806 and 1822). By finding the Activity Object (1864) and using the internal Transaction Name (1825), the proper TransactionMetrics Object (1826) is found and updated (1808).

FIG. 18 also shows the handling for TransactionEnd object (1851). This event represents the end and disposition (success or failure) of a coordinated Transaction. The TransactionEnd class abstracts the analysis from the fact that there can be two separate System Events: Transaction Commit and Transaction Rollback. When the TranscationEnd Object is created, its OnCreate action (1852) executes. Again, the mapping table (1560a) allows the lookup of the Component Object (1820) in step 1854. Step 1855 finds the Component (1820) and now the Activity Object (1824) again provides the link to the TransactionMetrics Object (1826) through the internal Transaction Name (1825). The metrics such as the coordinated transaction duration are then calculated (1856). The TransactionMetrics Object (1826) is updated with the metrics for the committed or aborted transaction.

Algorithm for Method Return and Method Exception

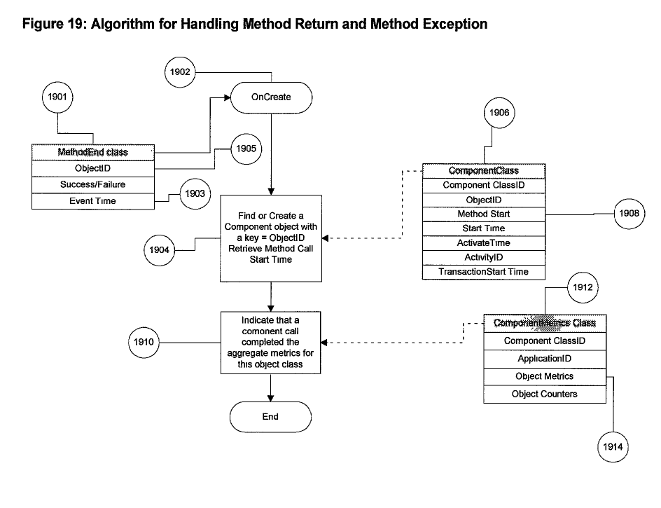

Like TransactionEnd, a Method End object (FIG. 19, 1901) represents the success or failure of a Method Call. The abstraction means that there could be a single System Event that passes the termination state, or that the invention can take one of two Events: a Method Successful Return or a Method Failure Return. Thus, the OnCreate Action (1902) represents the termination of a Method Call. Referring now to both FIGS. 17 and 19, to match the End with the invocation of the Call. (FIG. 17, 1701), the object for which this call is returning must be updated to indicate the result (1904). The proper Component Object (1906) is found by the Event Factory through the ObjectID property (1905). The Method Duration is computed by subtracting the Event Time (1903) from the Method Start Time (1908). The aggregate metrics (1914) for this type of Object (1912) will then be updated as well (1910).

Algorithm for Object Deactivation

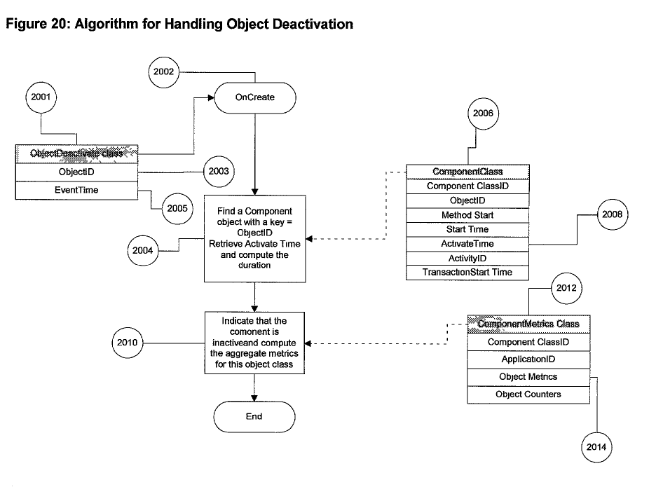

As shown in FIG. 20, Object Deactivation means that the resources for this Object are about to be cleaned up by the transactional object middleware. Object Deactivation is essentially a cleanup of the Object's resource—the Object Reference is still valid and may be activated at a later time. In the method of FIG. 20, an ObjectDeactivated Object (2001) is created in the Event Factory in response to a System Event indicating Object Deactivation. The OnCreate Action then (2002) fires, and Component Object (2006) is looked up (2004) using the ObjectID property (2003) from the ObjectDeactivated object (2001). With the help of the Event Time property (2005), the Activation Duration is calculated (2004) using the component's Activated Time property (2008). The Component Object is updated to indicate that it is Inactive (2010) and the aggregate metrics (2014) for this Component class (2012) are updated.

Algorithms for Object Destruction

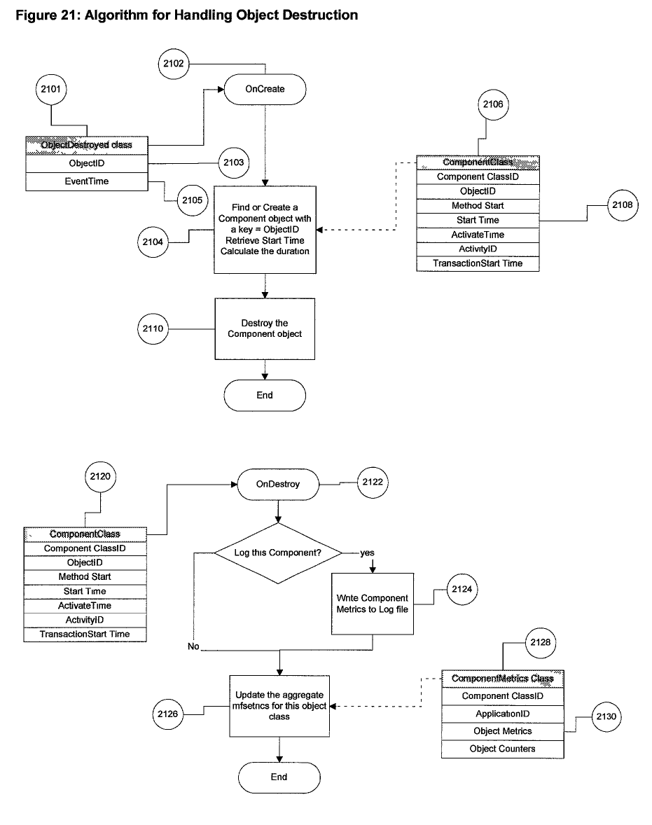

At a subsequent time, the Object's Caller is finished with the Object and indicates that the Object can be destroyed. FIG. 21 depicts the two-phase process that takes place. The work is divided between handling the ObjectDestroyed Object (2101) and the OnDelete Action (2122) for the Component Object (2120).

The OnCreate Action (2102) fires and the Component Object (2106) is looked up (2104) using the ObjectID property (2103) from the ObjectDestroyed Object (2101). Using the Event Time property (2105), the Activation Duration is calculated (2104) using the component's Start Time property (2108). The Component Object then is itself destroyed.

By destroying the Component Object, the Event Factory invokes the Component Class' (2120) OnDelete Action (2122). If logging for this object is enabled, the data for the Component is written to the Log File (2124). The final step is to update the aggregate metrics (2126) for this Component class (2126 and 2130).

Algorithm for Application Process Termination

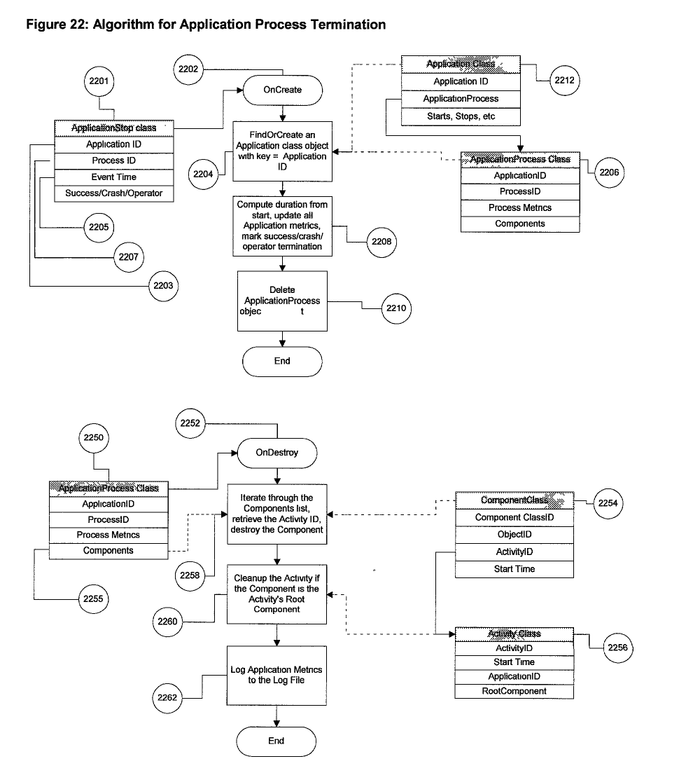

Application Process Termination (FIG. 22) uses a two-step process similar to that of Object Destruction (FIG. 21). One difference is that Applications are represented as two Objects: Application and ApplicationProcess (2212 and 2206 respectively). Only the ApplicationProcess Object is destroyed. The Application Object remains within the Event Factory, available to all for better tracking and reporting of application level metrics.

An ApplicationStop Object is created and the OnCreate Action (2202) fires. The Application (2212) and the ApplicationProcess (2206) Objects are looked up (2204) using the ApplicationID property (2203) and ProcessID (2207) from the ApplcationStop Object (2201). Using the Event Time property (2205), the process duration is calculated (2208). The Component object then is itself destroyed. The ApplicationProcess Object for representing the process (2206) is destroyed (2210).

The destruction of the ApplicationProcess Object (2206) invokes the OnDelete Action (2252) for the ApplicationProcess Class (2250). Cleanup means destroying all of the Component Objects (2254) on ApplicationProcess' Components list (2255). The Action iterates through this list (2258), retrieving each Component Object (2254). If this Component Object is the Root Component for the Activity (2260), then that Activity Object (2256) is also destroyed.

Finally, the metrics for this application process are logged to the Log File (2262).

Calculating Aggregate and Throughput Object Metrics:

The processes described up to this point deal with single instances. For example, the algorithm for Components describes the handling of a single Object instance. What is also useful is to keep track of counts and produce other metrics about the aggregate number of instances and what state they are in. At the end of many of the instance processing algorithms, the instance and its state are added or updated in another Object that keeps aggregate metrics. An example of such logic is depicted in FIG. 21 at 2128.

Raw counts are of only moderate interest. What is more useful is to produce rates from these counts. To produce rates, the counts must be measured over a fixed time interval and that time interval applied to these aggregates.

This is accomplished in the invention using the OnInterval Action for each of the Factory Object classes that produce rates: Application, ComponentMetrics and TransactionMetrics. FIG. 23 describes the algorithms using the Event Factory's OnInterval trigger mechanism. Applications Keep Rates, averages and standard deviations for the process level information are collected in FIG. 13. The Application Object's (2401) OnInterval action (2402) gets invoked on the Event Factory's fixed interval. It iterates over the Application Object's list of ApplicationProcess Objects (2404). For each ApplicationProcess Object (2410), the rate, average and standard deviation calculations are performed. The information is written to a Log File (2406), counters are reset to the appropriate beginning of Interval Value (2406) and then it loops to the next ApplicationProcess in the list (2406).

The process for the ComponentMetrics (2431) and TransactionMetrics (2461) classes is substantially dietetically. The Event Factory executes the OnInterval action for each Object in the class (2432 and 2462). The rates, averages and standard deviation calculations are performed, the information is written to the Log Files and counter values are reset to their beginning of Interval Values (2464).

Conclusion

The foregoing discloses methods, devices and systems for, inter alia, constructing a model of transactional object middleware components through a series of algorithms that collect and derive metrics based on events raised by the middleware. This model has value in understanding the many characteristics of the business-related computing system. From this model is derived a model for a business, by adding user-relevant names and data, and correlating this information against system performance data to achieve a meaningful scale.

It will be appreciated that the preceding discussion and the attached drawings disclose illustrative examples and possible practices of the invention, among others, and the scope of the invention is limited only by the appended claims.

1. A method for monitoring business transaction processing in an environment containing a number of component-based applications, wherein a first application emits a stream of events representative of a state transition or significant occurrence, the method comprising continuously:
detecting whether an event occurs in the first application, and for each event detected: a) capturing event data values corresponding to the event, wherein the event data values identify the application that generated the event and the time of the event generation; and b) collecting the event and the associated event data in a first event buffer; and
correlating events from the first event buffer into a correlation buffer, wherein the events in the correlation buffer are ordered according to the time of event generation;

2. A method for monitoring business transaction processing in an environment containing applications comprised of a plurality of components, wherein a first application emits a stream of events representative of a state transition or a significant occurrence, the method comprising continuously:
detecting whether an event occurs in the first application, and for each event detected: a) capturing event data values corresponding to the event, wherein the event data values identify the application that generated the event and the time of the event generation; and b) collecting the event and the associated event data in a first event buffer; and
associating each event to at least one other event to create a merged event; and
creating a transaction from the merged event, the transaction comprising a start, an end, and a duration, wherein a transaction is a single, atomic operation performed on behalf of a particular user.

3. The method of claim 1 or 2 further comprising collecting a set of transactions to form a real-time transactional model of the business transaction processing.

4. The method of claim 1 or 2 wherein creating a transaction further comprises:
creating a model of the components of the application from the merged events; and
creating the transaction from the model and other merged events.

5. The method of claim 1 or 2 further comprising a second application emitting a stream of events, the method further comprising:
detecting whether an event occurs in the second application, and for each event detected: a) capturing event data values corresponding to the event, wherein the event data values identify the application that generated the event and the time of the event generation; and b) collecting the event and the associated event data in a second event buffer; and
combining the events from the first event buffer and the second event buffer into a correlation buffer, wherein the events in the correlation buffer are ordered according to the time of event generation.

6. The method of claim 1 or 2 wherein creating a transaction further comprises:
determining a begin event of the transaction;
determining a component employed by the transaction;
determining an end event of the transaction;
determining a transaction duration; and
determining a transaction name.

7. The method of claim 6 wherein determining a begin event further comprises determining whether an event is a root object method call, and if the event is a root object method call, assigning the root object method call as the begin event of the transaction.

8. The method of claim 6 wherein determining an end event further comprises determining whether an event is a method return event and if the event is a method return event, assigning the method return event as the end event of the transaction.

9. The method of claim 6 wherein collecting a set of transactions to form a real-time transactional model of the business transaction processing further comprises:
partitioning transactions into transaction sets based on the transaction name; and
determining an active number of transactions and a completed number of transactions.

10. The method of claim 1 or 2 further comprising:
detecting a system event generated by an operating system, wherein the system event provides data descriptive of a process executing a transaction; and
correlating the system event with the transaction.

11. The method of claim 10 further including:
collecting a series of system events; and
generating a performance curve of the system using the system events.

12. The method of claim 11 further including correlating the set of transactions and the performance curve of the system to evaluate the business transaction processing.
